(19) United States
(12) Patent Application Publication
(10) Pub. No.: US 2024/0221106 A1
(43) Pub. Date: Jul. 4, 2024

(54) Intermediate System, Intermediate Method, And Ride-Offering System

(71) Applicants: Hyundai Motor Company, Seoul (KR); Kia Corporation, Seoul (KR)

(72) Inventors: Minjae Park, Seongnam-Si (KR); Jungdo Kim, Seoul (KR); Jaemin Moon, Yongin-Si (KR); Sungwang Kim, Seoul (KR)

(21) Appl. No.: 18/538,335

(22) Filed: Dec. 13, 2023

(30) Foreign Application Priority Data
Dec. 28, 2022 (KR) 10-2022-0187478

(51) Int. Cl. G06Q 50/40; G06Q 10/083

(52) U.S. Cl. CPC G06Q 50/40; G06Q 10/083

(57) ABSTRACT

An intermediate system may include: a communication module configured to communicate with a ride-offering system and a delivery system; and at least one processor configured to perform matching on a ride request transmitted to the ride-offering system and a delivery request transmitted to the delivery system, wherein, in response to a delivery request matching the ride request being existent, the at least one processor is configured to change at least one of an origin or a destination of a ride-offering service corresponding to the ride request based on the matching delivery request.

### CROSS-REFERENCE TO RELATED APPLICATION

This application is based on and claims priority to Korean Patent Application No. 10-2022-0187478, filed on Dec. 28, 2022 in the Korean Intellectual Property Office, the disclosure of which is incorporated herein by reference.

### TECHNICAL FIELD

The disclosure relates to an intermediate system, an intermediate method and a ride-offering system that may intermediate a ride-offering service and a delivery service.

### BACKGROUND

Various types of ride-offering service may be provided to users, in addition to ride-offering services such as taxis and public transportation.

Such ride-offering services are categorized as car-sharing, car-hailing, ride-hailing, ride-sharing and taxi-hailing depending on how a vehicle is provided.

The above-described categorization may be made based on whether a vehicle is provided together with a driver, whether a vehicle is provided to a location where a user called the vehicle, whether a single vehicle is provided to multiple users, or whether a vehicle offered is a registered taxi.

More purchases may be made online, leading to an increase in demand for delivery services.

Because both ride-offering service and delivery service may be based on vehicles, more efficient services may be provided if the two services are linked.

### SUMMARY

A system (e.g., intermediate system) may comprise a communication module configured to communicate with a ride-offering system and a delivery system; and at least one processor configured to: perform matching between: a ride request transmitted to the ride-offering system and a delivery request transmitted to the delivery system; and based on the performed matching, change at least one of an origin associated with the ride request or a destination associated with the ride request. The at least one processor may be further configured to compare: a pair of the origin and the destination associated with the ride request and a pair of a pickup location and a drop-off location associated with the delivery request.

The at least one processor may be further configured to determine, based on a distance between the origin associated with the ride request and a pickup location associated with the delivery request being equal to or less than a reference value and a distance between the destination associated with the ride request and a drop-off location associated with the delivery request being equal to or less than the reference value, whether the delivery request and the ride request match. The at least one processor may be configured to determine, based on a distance between the origin associated with the ride request and a pickup location associated with the delivery request being equal to or less than a first reference value, a user associated with the ride request as a user for picking up an item associated with the delivery request.

The at least one processor may be further configured to determine, based on a distance between the destination associated with the ride request and a drop-off location associated with the delivery request being equal to or less than a first reference value, a user associated with the ride request as a user for delivering an item associated with the delivery request. The at least one processor may be further configured to determine, based on: a distance between the origin associated with the ride request and a pickup location associated with the delivery request exceeding a first reference value and a distance between the origin associated with the ride request and a location associated with a vehicle being equal to or less than a second reference value, a user of the vehicle as a user for picking up an item associated with the delivery request, wherein the vehicle is adjacent to the origin associated with the ride request.

The at least one processor may be further configured to determine, based on a distance between the destination associated with the ride request and a drop-off location associated with the delivery request exceeding a first reference value, a user of a vehicle adjacent to the origin associated with the ride request as a user for delivering an item associated with the delivery request. The at least one processor may be further configured to calculate, based on the performed matching, a reward for participating in a delivery service associated with the delivery request. The at least one processor may be further configured to calculate the reward based on at least one of: a travel distance associated with a pickup or a delivery of an item, a size of the item, or a weight of the item.

According to the present disclosure, a method performed by a computing device (e.g., intermediate system), the method may comprise receiving information related to a ride request from a ride-offering system; performing matching between the ride request and a delivery request transmitted to a delivery system; and based on the performed matching, changing at least one of an origin or a destination associated with the ride request. The performing matching may comprise comparing: a pair of the origin and the destination associated with the ride request and a pair of a pickup location and a drop-off location associated the delivery request.

The performing matching may comprise determining, based on a distance between the origin associated with the ride request and a pickup location associated with the delivery request being equal to or less than a reference value and a distance between the destination associated with the ride request and a drop-off location associated with the delivery request being equal to or less than the reference value, whether the delivery request and the ride request match. The performing matching may comprise determining, based on a distance between the origin associated with the ride request and a pickup location associated with the delivery request being equal to or less than a first reference value, a user associated with the ride request as a user for picking up an item associated with the delivery request. The performing matching may comprise determining, based on a distance between the destination associated with the ride request and a drop-off location associated with the delivery request being equal to or less than a first reference value, a user associated with the ride request as a user for delivering an item associated with the delivery request.

The performing matching may comprise determining, based on: a distance between the origin associated with the ride request and a pickup location associated with the delivery request exceeding a first reference value and a distance between the origin associated with the ride request and a location associated with a vehicle being equal to or less than a second reference value, determine a user of the vehicle as a user for picking up an item associated with the delivery request, wherein the vehicle is adjacent to the origin associated with the ride request. The performing matching may comprise determining, based on a distance between the destination associated with the ride request and a drop-off location associated with the delivery request exceeding a first reference value, a user of a vehicle adjacent to the origin associated with the ride request as a user for delivering an item associated with the delivery request. The performing matching may comprise calculating, based on the performed matching, a reward for participating in a delivery service associated with the delivery request.

According to the present disclosure, a system (e.g., a ride-offering system) may comprise a communication module configured to communicate with a user terminal, a driver terminal, and a delivery system; and at least one processor configured to: perform matching between: a ride request transmitted from the user terminal and a delivery request transmitted to the delivery system; and based on the performed matching, change at least one of an origin or a destination associated with the ride request. The at least one processor is further configured to compare: a pair of the origin and the destination associated with the ride request and a pair of a pickup location and a drop-off location associated the delivery request. The at least one processor is further configured to determine, based on a distance between the origin associated with the ride request and a pickup location associated with the delivery request being equal to or less than a reference value and a distance between the destination associated with the ride request and a drop-off location associated the delivery request being equal to or less than the reference value, whether the delivery request and the ride request match.

The at least one processor is further configured to determine, based on a distance between the origin associated with the ride request and a pickup location associated with the delivery request being equal to or less than a first reference value, a user associated with the ride request as a user for picking up an item associated with the delivery request. The at least one processor is further configured to determine, based on a distance between the destination associated with the ride request and a drop-off location associated with the delivery request being equal to or less than a first reference value, a user associated with the ride request as a user for delivering an item associated with the delivery request. The at least one processor is further configured to determine, based on: a distance between the origin associated with the ride request and a pickup location associated with the delivery request exceeding a first reference value and a distance between the origin associated with the ride request and a location associated with a vehicle being equal to or less than a second reference value, determine a user of the vehicle as a user for picking up an item associated with the delivery request, wherein the vehicle is adjacent to the origin associated with the ride request.

The at least one processor is further configured to determine, based on to a distance between the destination associated with the ride request and a drop-off location associated with the delivery request exceeding a first reference value, a user of a vehicle adjacent to the origin associated with the ride request as a user for delivering an item associated with the delivery request. The at least one processor is further configured to calculate, based on the performed matching, a reward for participating in a delivery service associated with the delivery request.

### BRIEF DESCRIPTION OF THE DRAWINGS

These and/or other examples of the disclosure will become apparent and more readily appreciated from the following description of the examples, taken in conjunction with the accompanying drawings of which:

FIG. 1 shows an example of a diagram showing a relationship among an intermediate system, a ride-offering system and a delivery system;

FIG. 2 shows an example of a diagram showing constituent components of an intermediate system, a ride-offering system and a delivery system;

FIG. 3 showing an example of a flowchart showing steps of an intermediate method;

FIG. 4, FIG. 5, FIG. 6, and FIG. 7 show examples of diagrams showing a process of providing a ride-offering service and a delivery service by an intermediate system, a ride-offering system and a delivery system;

FIG. 8, FIG. 9, FIG. 10, and FIG. 11 show examples of information displayed on a mobile device of a user if the user performs both pickup and delivery of an item;

FIG. 12 shows an example of a table showing calculating a reward provided to a user or a driver, if a ride-offering service and a delivery service are linked according to an intermediate method; and

FIG. 13 shows an example of a diagram showing an example where a ride-offering service and a delivery service are intermediated by a ride-offering system.

### DETAILED DESCRIPTION

The examples set forth herein and illustrated in the configuration of the present disclosure are only preferred examples, so it should be understood that they may be replaced with various equivalents and modifications at the time of the present disclosure.

Terminologies used herein are for the purpose of describing particular examples only and is not intended to limit the present disclosure. It is to be understood that the singular forms are intended to include the plural forms as well, unless the context clearly dictates otherwise.

It will be further understood that the terms “include”, “comprise” and/or “have” if used in this specification, specify the presence of stated features, integers, steps, operations, elements, and/or components, but do not preclude the presence or addition of one or more other features, integers, steps, operations, elements, components, and/or groups thereof.

Further, the terms such as “˜part”, “˜device”, “˜block”, “˜member”, “˜module”, and the like may refer to a unit for processing at least one function or act. For example, the terms may refer to at least a process processed by at least one hardware component, such as a field-programmable gate array (FPGA) and/or an application specific integrated circuit (ASIC), or software stored in memories or processors.

It will be understood that, although the terms first, second, etc. may be used herein to describe various elements, these elements should not be limited by these terms.

Reference numerals used for method steps are just used for convenience of explanation, but not to limit an order of the steps. Thus, unless the context clearly dictates otherwise, the written order may be practiced otherwise.

The term “at least one” used herein includes any and all combinations of the associated listed items. For example, it should be understood that the term “at least one of A, B, or C” may include only A, only B, only C, both A and B, both A and C, both B and C, or all of A, B and C.

Hereinafter, examples of the disclosure are described in detail with reference to the accompanying drawings.

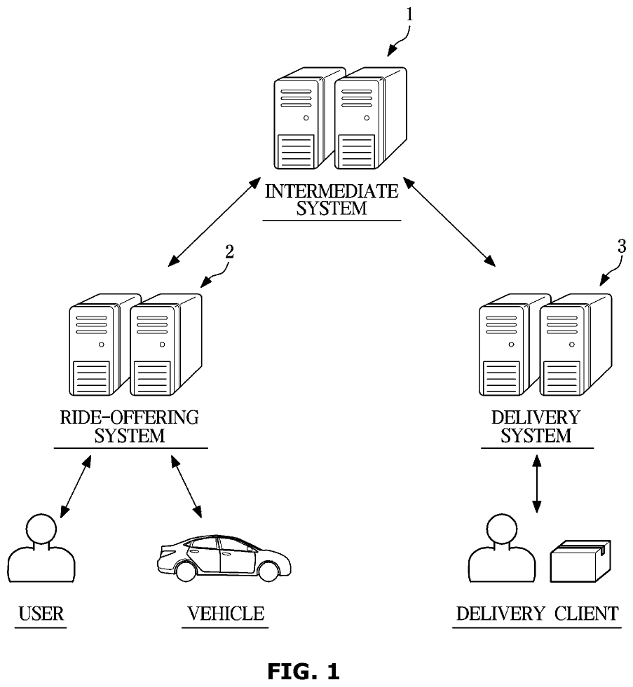

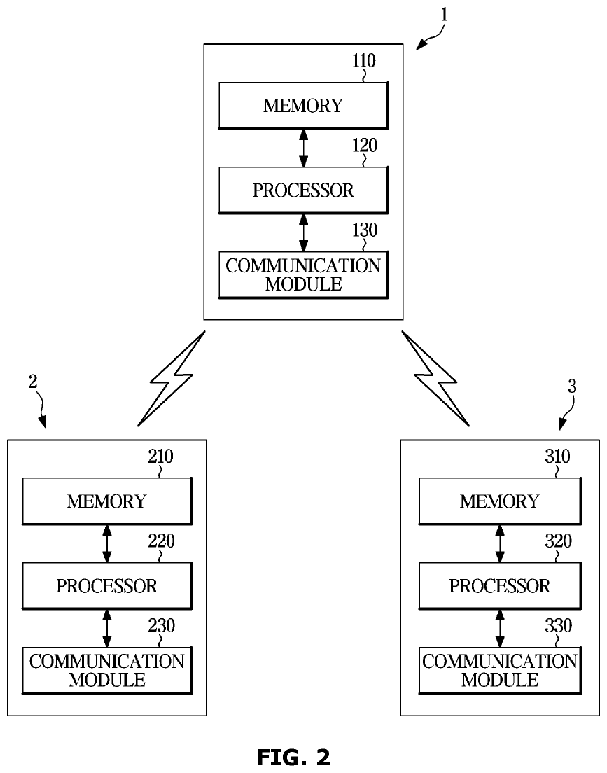

FIG. 1 shows an example of a diagram showing a relationship among an intermediate system, a ride-offering system and a delivery system according to an example. FIG. 2 shows an example of a diagram showing constituent components of an intermediate system, a ride-offering system and a delivery system according to an example.

According to an example, a ride-offering system 2 is a system of providing a vehicle to a user desiring to travel by vehicle, and may be divided into car-sharing, car-hailing, ride-hailing, ride-sharing and taxi-hailing depending on how a vehicle is provided.

All of the following methods may be applicable to the ride-offering system 2 according to an example: a method of providing a user with a driver and a vehicle, a method of providing a vehicle only, a method of using a vehicle solely by a user, a method of sharing a vehicle with other users.

A delivery system 3 may provide a delivery service to a recipient which is a buyer who has purchased an item and a delivery client which is a seller who has sold the item to the buyer. Types of items sold may not be limited.

Referring to FIG. 1, an intermediate system 1 according to an example may serve as an intermediary between the ride-offering system 2 and the delivery system 3. Specifically, the intermediate system 1 may compare a ride request input to the ride-offering system 2 and a delivery request input to the delivery system 3, and perform matching on the ride request and the delivery request based on an origin and a destination of the ride request and a pickup location and a drop-off location of the delivery request.

If the ride request and the delivery request match, the matching delivery request may be offered to a user who has made the ride request or a driver of a vehicle assigned to the ride request.

Once the user or the driver accepts the delivery offer, the origin or the destination of the ride-offering service may be changed depending on who accepts the offer.

For example, if the user accepts the delivery offer, the origin and the destination of the ride-offering service may be changed to the pickup location and the drop-off location of the delivery request, respectively.

The user may move to the pickup location and pick up an item, and then get on a vehicle. If the vehicle arrives at the drop-off location, the user may exit the vehicle, deliver the item to the drop-off location, and then head to the destination.

Referring to FIG. 2, the intermediate system 1 may include at least one memory 110 storing a program performing the operations to be described later, at least one processor 120 implementing a stored program, and a communication module 130 communicating with the ride-offering system 2 and the delivery system 3.

The communication module 130 may wirelessly communicate with a base station or an access point (AP), and exchange data with external devices through a base station or an access point.

For example, the communication module 130 (e.g., transceiver) may wirelessly communicate with an access point using Wi-Fi (Wi-Fi⊚, IEEE 802.11 standard), or communicate with a base station using a code division multiple access (CDMA), wideband CDMA (WCDMA), global system for mobile communication (GSM), long term evolution (LTE), 5G, Wibro, and the like.

The ride-offering system 2 includes at least one memory 210 storing a program performing the operations to be described later, at least one processor 220 implementing a stored program, and a communication module 230 communicating with the intermediate system 1 and a user terminal and a driver terminal of the ride-offering service.

The communication module 230 may wirelessly communicate with a base station or an access point (AP), and exchange data with external devices through a base station or an access point.

For example, the communication module 230 may wirelessly communicate with an access point using Wi-Fi (Wi-Fi⊚, IEEE 802.11 standard), or communicate with a base station using a CDMA, WCDMA, GSM, LTE, 5G, Wibro, and the like.

The delivery system 3 includes at least one memory 310 storing a program performing the operations to be described later, at least one processor 320 implementing a stored program, and a communication module 330 communicating with the intermediate system 1, a delivery client and a recipient.

The communication module 330 may wirelessly communicate with a base station or an access point (AP), and exchange data with external devices through a base station or an access point.

For example, the communication module 330 may wirelessly communicate with an access point using Wi-Fi (Wi-Fi⊚, IEEE 802.11 standard), or communicate with a base station using a CDMA, WCDMA, GSM, LTE, 5G, Wibro, and the like.

As an example, each of the intermediate system 1, the ride-offering system 2 and the delivery system 3 may be implemented as a server.

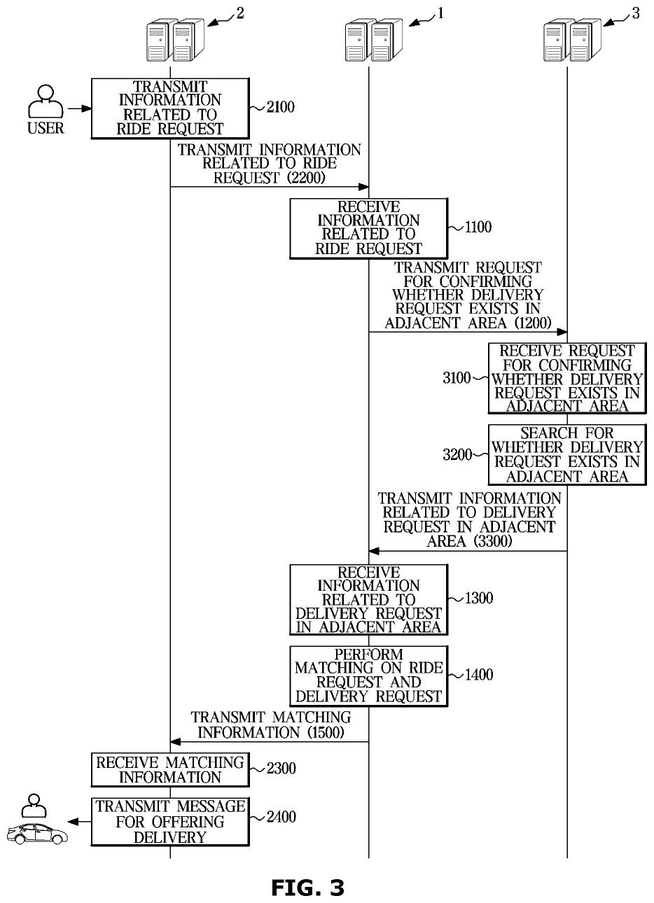

FIG. 3 shows an example of a flowchart showing steps of an intermediate method according to an example.

An intermediate method according to an example may be performed by the above-described intermediate system 1, and a ride-offering service provided by the ride-offering system 2 and a delivery service provided by the delivery system 3 may be intermediated by the intermediate system 1.

The above description on the intermediate system 1 may be applied to the intermediate method according to an example, and a description on the intermediate method to be described below is also applicable to the intermediate system 1, even if not specifically described below.

Referring to FIG. 3, if a user inputs a ride request using a user terminal such as a mobile device, and the like, the input ride request is transmitted to the ride-offering system 2. The ride request may include information about an origin and a destination.

The ride-offering system 2 may receive the ride request (2100), and transmit information related to the received ride request to the intermediate system 1 (2200).

If the ride request is received, the ride-offering system 2 may search for a vehicle adjacent to the origin included in the ride request. Hereinafter, the vehicle adjacent/close to or in proximity to the origin included in the ride request is referred to as a share vehicle.

The information related to the ride request transmitted by the ride-offering system 2 to the intermediate system 1 may include information about the share vehicle as well as the information about the origin and the destination. Also, the information related to the ride request may include an estimated required time from the origin to the destination.

The vehicle adjacent to the origin, i.e., the share vehicle may be a vehicle located within a predetermined distance from the origin among vehicles registered in the ride-offering system 2. Information about a vehicle adjacent to an origin may include information about a location of the vehicle adjacent to the origin and a time taken for the vehicle to move to the origin.

The intermediate system 1 may receive the information related to the ride request (1100), and transmit, to the delivery system 3, a request to confirm whether a delivery request exists in an adjacent area (1200).

Specifically, the intermediate system 1 may transmit, to the delivery system 3, the request for confirming the delivery request having a pickup location, which is adjacent to the origin included in the ride request or a location of a driver, and a drop-off location which is adjacent to the destination included in the ride request. Here, an adjacent location (adjacent area) may refer to an area where a distance between two locations is less than a predetermined reference value.

The delivery system 3 may receive the request for confirming whether the delivery request exists in the adjacent area (3100), and search for whether the delivery request exists in the adjacent area (3200). If the delivery request is retrieved, the delivery system 3 may transmit information related to the delivery request in the adjacent area to the intermediate system 1 (3300).

The information related to the delivery request may include information about a pickup location, a drop-off location and an item to be delivered. Also, the information related to the delivery request may further include information about an estimated delivery time and a delivery time limit. For example, the delivery time limit may be determined based on types of item to be delivered.

The intermediate system 1 may receive the information related to the delivery request in the adjacent area (1300), and perform matching on the ride request and the delivery request based on the received information related to the delivery request (1400).

To perform matching, the intermediate system 1 may compare a distance between the origin of the ride request or the driver's location and the pickup location of the delivery request with a reference value, and compare a distance between the destination of the ride request and the drop-off location of the delivery request with a reference value.

Here, the reference value may vary depending on whether the pickup or delivery is performed by the user or the driver. Also, the above two reference values for comparison may be the same or different from each other.

Specifically, if the distance between the origin of the ride request and the pickup location of the delivery request is equal to or less than a first reference value, the intermediate system 1 may determine that the user inputting the ride request will pick up the item. Here, the first reference value may be a distance that the user is able to travel on foot, for example, 500 m.

If the distance between the origin of the ride request and the pickup location of the delivery request exceeds the first reference value and a distance between the origin of the ride request and a location of the adjacent vehicle (share vehicle) is equal to or less than a second reference value, the intermediate system 1 may determine that the driver of the share vehicle will pick up the item. Here, the second reference value may be determined based on a movement of vehicle, for example, 2 km.

If the distance between the destination of the ride request and the drop-off location of the delivery request is equal to or less than a first reference value, the intermediate system 1 may determine that the user inputting the ride request will deliver the item. Here, the first reference value may be a distance that the user is able to travel on foot, for example, 500 m.

If the distance between the destination of the ride request and the drop-off location of the delivery request exceeds the first reference value, the intermediate system 1 may determine that the driver of the share vehicle will deliver the item.

If the distance between the origin of the ride request and the pickup location of the delivery request exceeds the first reference value and a distance between a current location of the adjacent vehicle (share vehicle) and the pickup location of the delivery request exceeds the second reference value, the intermediate system 1 may determine that no delivery request matching the ride request exists.

In other cases, the intermediate system 1 may determine that the delivery request matching the ride request exists. Also, as described above, a subject who performs the pickup and delivery may vary depending on the distance between the origin of the ride request and the pickup location of the delivery request and the distance between the destination of the ride request and the drop-off location of the delivery request.

The intermediate system 1 may change at least one of the origin or the destination of ride-offering service depending on the subject who performs the pickup and delivery. That is, at least one of the origin or the destination of the ride-offering service may be changed based on the distance between the origin of the ride request and the pickup location of the delivery request and the distance between the destination of the ride request and the drop-off location of the delivery request. Here, the ride-offering service may refer to a service corresponding to the ride request, that is, a service provided to the user requesting a ride.

For example, if the user performs both pickup and delivery, the origin of the ride-offering service may be changed to the pickup location of item and the destination of the ride-offering service may be changed to the drop-off location of the item.

Alternatively, if the user picks up an item and the driver delivers the item, the origin of the ride-offering service may be changed to the pickup location of item without changing the destination of the ride-offering service.

Alternatively, if the driver performs both pickup and delivery, the origin and the destination of the ride-offering service may be unchanged.

Alternatively, if the driver picks up an item and the user delivers the item, the destination of the ride-offering service may be changed to the drop-off location of item, without changing the origin of the ride-offering service.

If a delivery route is changed because the user or driver performs pickup and delivery, the intermediate system 1 may calculate a delay time.

Specifically, the intermediate system 1 may calculate the delay time based on a required time estimated based on a delivery route before change and a required time estimated based on a delivery route after change.

The intermediate system 1 may compare the calculated delay time with a reference value, and if the calculated delay time exceeds the reference value, cancel a link between the ride-offering service and delivery service. Here, the reference value for comparison with the delay time may vary depending on types of item. If information about the delivery time limit is provided from the delivery system 3, the reference value may be determined based on the delivery time limit.

For example, if an item to be delivered is food, the reference value may be set smaller than that of non-food items, and if an item to be delivered is food that may be melted or cooled, the reference value may be set much smaller.

As described above, if it is determined that the user or driver performs pickup and delivery and a delay time due to a changed delivery route does not exceed the reference value, the intermediate system 1 may determine that the corresponding delivery request and the ride request match.

The intermediate system 1 may transmit matching information of the delivery request and the ride request to the ride-offering system 2 (1500).

The matching information of the delivery request and the ride request may include the pickup location and the drop-off location of item, and a subject who performs pickup and delivery.

The ride-offering system 2 may receive the matching information of the delivery request and the ride request (2300), and transmit a message for offering delivery to the user or driver based on the received matching information (2400).

If it is determined that the user performs both pickup and delivery, the message may be transmitted to the user. The message may be displayed on a user terminal.

Alternatively or additionally, if it is determined that the user picks up an item and the driver delivers the item, or the driver picks up an item and the user delivers the item, the message may be transmitted to each of the user and the driver. The message may be displayed on each of a user terminal and a driver terminal.

Alternatively or additionally, if it is determined that the driver performs both pickup and delivery, the message may be transmitted to the driver. The message may be displayed on a driver terminal.

Once the user or the driver accepts the delivery offer, the link between the ride-offering service and delivery service is established, and if either the user or the driver rejects the offer, the link between the ride-offering service and the delivery service is not established.

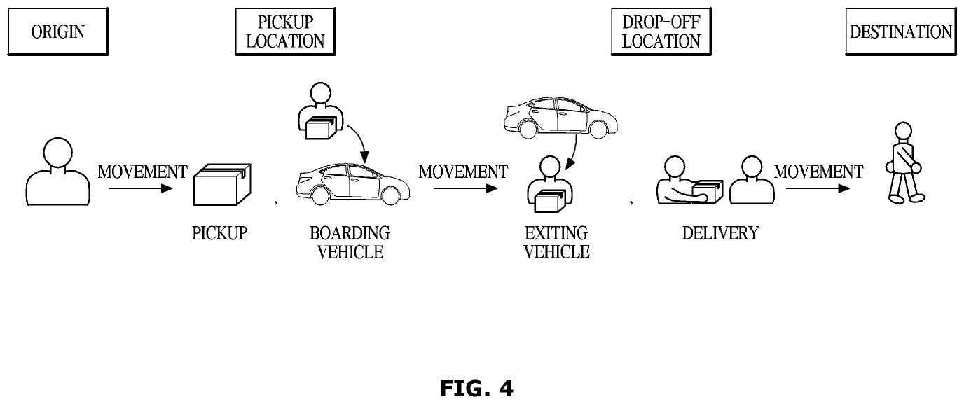

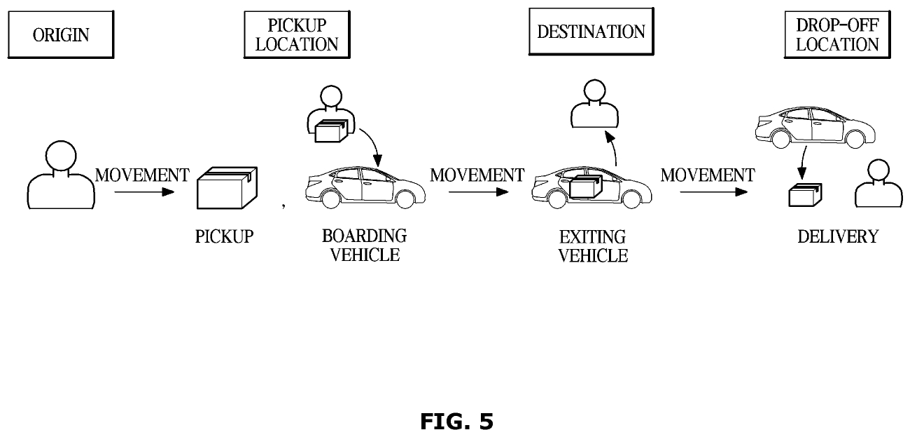

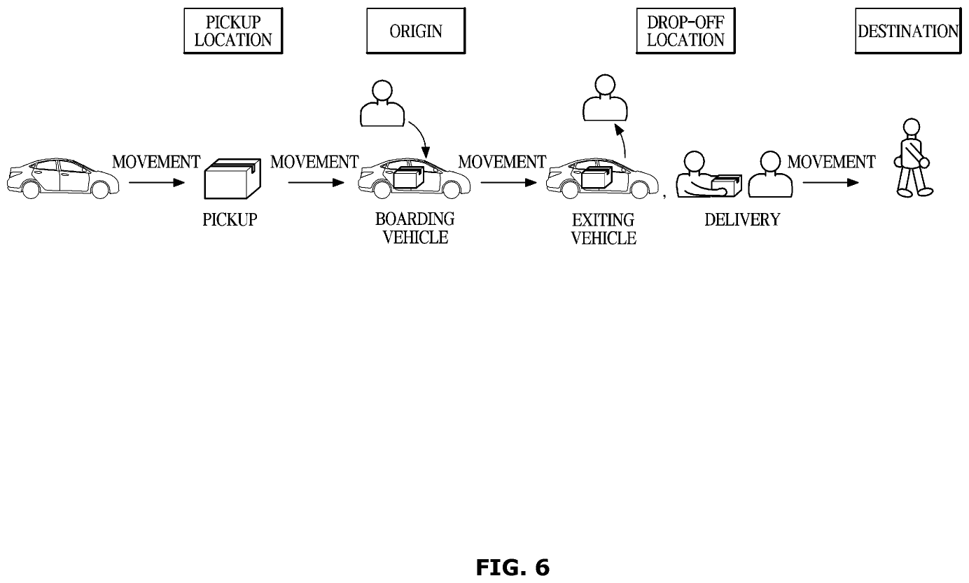

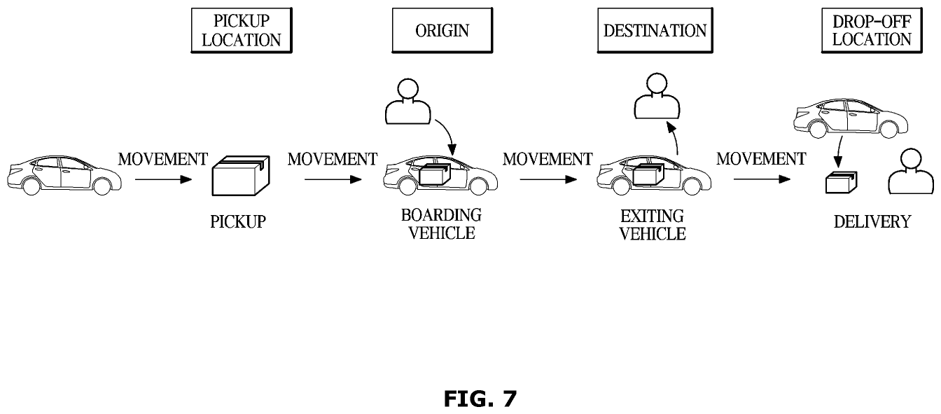

FIG. 4 to FIG. 7 shows examples of diagrams showing a process of providing a ride-offering service and a delivery service by an intermediate system, a ride-offering system and a delivery system according to an example.

As described above, if a ride request is input to the ride-offering system 2, the intermediate system 1 may compare an origin and a destination of the ride request with a pickup location and a drop-off location of a delivery request, and search for a delivery request and the ride request that match each other.

If the matching delivery request is retrieved and a user inputting the ride request or a driver of a vehicle assigned to the ride request accepts an offer of the matching delivery request, the user or the driver may became a performer of the corresponding delivery.

It is shown in FIG. 4 that a user of the ride-offering service may perform both pickup and delivery of an item requested to be delivered. In this case, an origin of the ride-offering service may be changed to a pickup location of a delivery request, and a destination of the ride-offering service may be changed to a drop-off location of the delivery request.

Referring to FIG. 4, the user may move to the pickup location of the delivery request and pick up the item, and a vehicle assigned to a ride request may move to the pickup location as well.

The user who has picked up the item may board the vehicle, and the vehicle may move to the drop-off location. In this instance, the vehicle may be provided together with the driver, and if the vehicle arrives at the drop-off location, the user may exit the vehicle together with the item.

The user may finish the delivery of the item and head to a user's original destination.

It is shown in FIG. 5 that a user of the ride-offering service may perform pickup of an item requested to be delivered, and a driver assigned to the ride-offering service performs delivery of the item. In this case, an origin of the ride-offering service may be changed to a pickup location of a delivery request.

Referring to FIG. 5, the user may move to the pickup location of the delivery request and pick up the item, and a vehicle assigned to the ride-offering service may move to the pickup location as well.

The user who has picked up the item may board the vehicle, and the vehicle may move to a drop-off location of the item. In this instance, the vehicle may be provided together with the driver, and if the vehicle arrives at a destination of the user, the user may exit the vehicle. The item may be handed over to the driver.

After the user exits the vehicle, the vehicle may move to the drop-off location and finish the delivery.

It is shown in FIG. 6 that a driver assigned to the ride-offering service may perform pickup of an item requested to be delivered, and a user requesting the ride-offering service performs delivery of the item. In this case, a destination of the ride-offering service may be changed to a pickup location of a delivery request.

Referring to FIG. 6, a vehicle assigned to the ride-offering service may move to the pickup location of the delivery request, pick up the item, and move to an origin of the ride-offering service to pick up the user.

The vehicle with the user may move to a drop-off location of the item. Once arrived at the drop-off location, the user may exit the vehicle together with the item to finish the delivery. After the delivery is completed, the user may head to a user's original destination.

It is shown in FIG. 7 that a driver assigned to the ride-offering service may perform both pickup and delivery of an item requested to be delivered.

Referring to FIG. 7, a vehicle assigned to the ride-offering service may move to a pickup location of a delivery request, pick up the item, and move to an origin of the ride-offering service.

If a user boards the vehicle at the origin of the ride-offering service, the vehicle may move to a destination of the ride-offering service. Once arrived at the destination, the user may exit the vehicle.

After the user exists the vehicle, the driver may move to a drop-off location of the delivery request to finish the delivery.

Meanwhile, if a link between the ride-offering service and delivery service is established, the ride-offering system 2 may additionally provide guidance information for delivery of the user or driver, in addition to information for providing the ride-offering service.

For example, if a user performs at least one of pickup or delivery of an item, information about a pickup location or a drop-off location of the item may be provided to the user. The provided information may be displayed on a mobile device of the user.

If a driver performs at least one of pickup or delivery of an item, information about a pickup location or a drop-off location of the item may be provided to the driver. The provided information may be displayed on a mobile device of the driver.

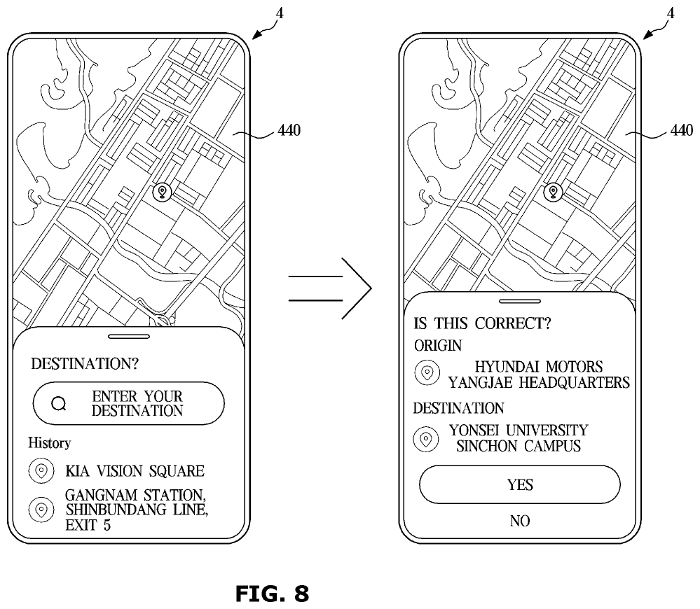

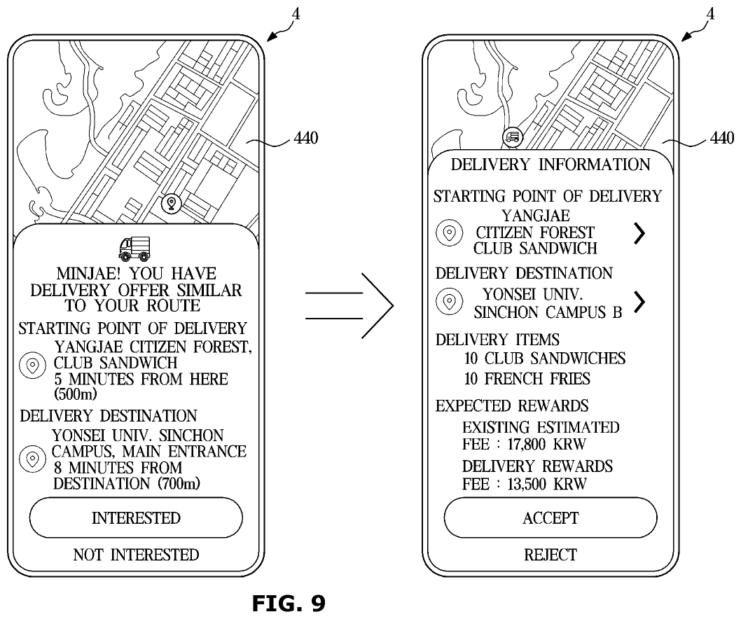

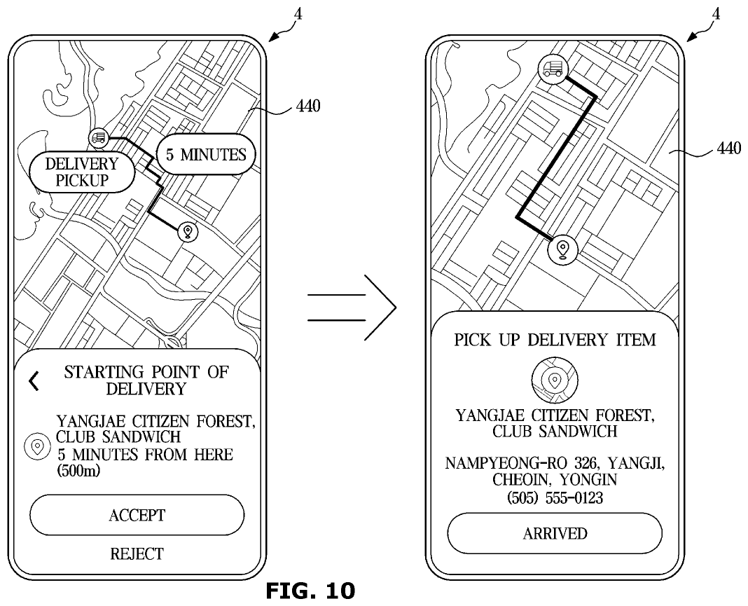

FIG. 8 to FIG. 11 show examples of information displayed 440 on a mobile device of a user if the user performs both pickup and delivery of an item.

An application for use of a ride-offering service may be installed in a mobile device 4 of a user. If the user executes the application, a screen for inputting a destination may be displayed, as shown on a left side of FIG. 8.

As an example, if the user inputs ‘Hyundai Motors Yangjae headquarters’ as a destination, a screen for confirming the destination and an origin may be displayed, as shown on a right side of FIG. 8.

Here, the origin may be set to a current location of the user as a default value, but may be changed to another location according to a user's selection.

If the destination and the origin are completely set, the mobile device 4 may generate a ride request including information about the destination and the origin, and transmit the generated information to the ride-offering system 2.

The ride-offering system 2 may receive the ride request and transmit information related to the ride request to the intermediate system 1. The information related to the ride request may include the destination and the origin, and further include information about an estimated required time and a vehicle adjacent to the origin.

The intermediate system 1 may transmit a request for confirming whether a delivery request exists in adjacent areas, to the delivery system 3. The delivery system 3 may search for the delivery request existing in the adjacent areas and transmit information related to the retrieved delivery request to the intermediate system 1. The information related to the delivery request may include information about a pickup location, a drop-off location and an item to be delivered.

The intermediate system 1 may perform matching on the ride request and the delivery request based on the received information related to the delivery request. An operation of matching has been described above.

Hereinafter, described is an example where a delivery request matching a ride request exists, and a user performs both pickup and delivery of an item. In this case, as shown on a left side of FIG. 9, a message for offering a performance of the matching delivery request may be displayed on the mobile device 4 of the user.

Information about a pickup location (origin) and a drop-off location (destination) of the item may be displayed on the mobile device 4. Specifically, a location of the pickup location and a distance from a current location or a required time may be displayed, and a location of the drop-off location and a distance to the destination or a required time may also be displayed.

In addition, as shown on a right side of FIG. 9, details on a delivery offer may be further displayed. For example, information about the item to be delivered may be displayed. The information about the item may include a type of item and the number of items.

Information about rewards to be provided if accepting the delivery offer may also be displayed. Details on reward calculation will be described later.

The user may accept or reject the delivery offer. If the user accepts the delivery offer, a navigation screen may be displayed to guide a route to the pickup location, as shown in FIG. 10. If the user accepts the delivery offer, the origin and the destination of the ride-offering service may be changed to the pickup location and the drop-off location, respectively.

Accordingly, a vehicle assigned to the ride request may move to the pickup location, not the origin initially input by the user. If the user moves to the pickup location and picks up the item, information about the assigned vehicle may be displayed on the mobile device 4, as shown in FIG. 11. The information displayed 440 may include information about an estimated arrival time, a location of the vehicle, or a driver.

If the vehicle arrives, the user may board the vehicle with the picked-up item, and if the vehicle arrives at the drop-off location, a message for notifying the arrival of the drop-off location may be displayed on the mobile device 4.

In addition, a screen for inputting completion of delivery may be displayed on the mobile device 4, and if the user inputs completion of delivery, payment reflecting the reward may be made.

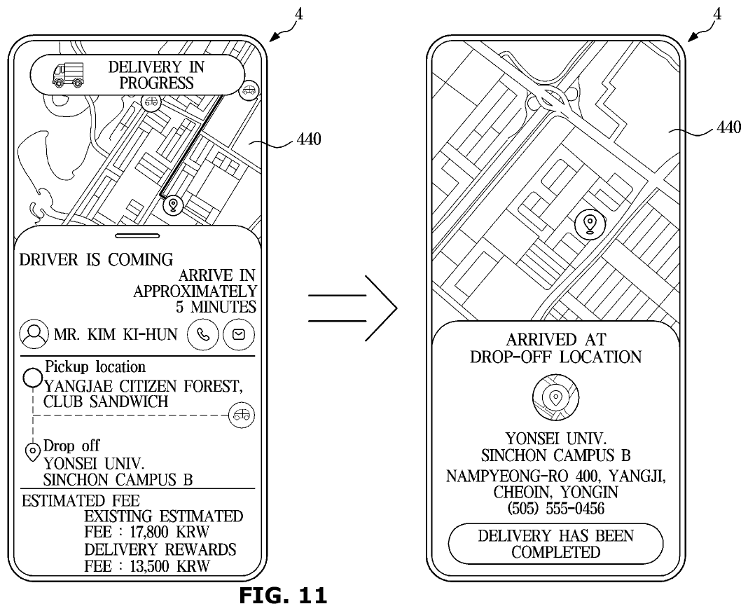

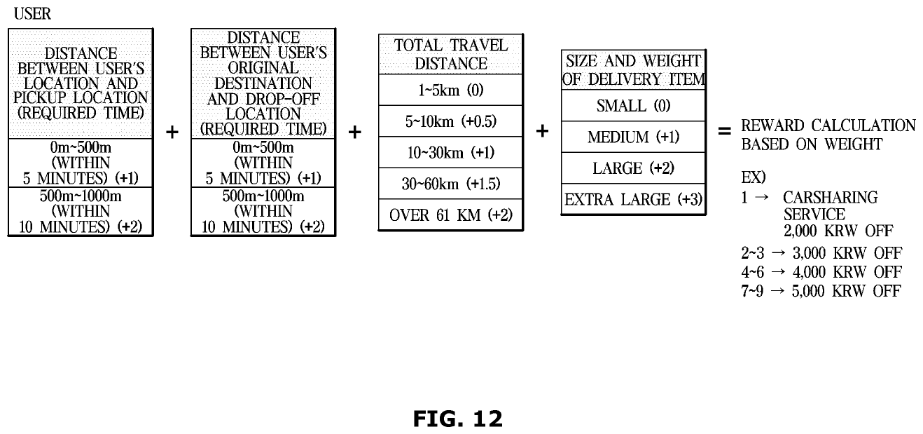

FIG. 12 shows an example of a table showing calculating a reward provided to a user or a driver, if a ride-offering service and a delivery service are linked according to an intermediate method according to an example.

Referring to FIG. 12, if a user of the ride-offering service performs both pickup and delivery of an item, a weight may be calculated based on a distance between a current location of the user and a pickup location of the item, and a weight may be calculated based on a distance between an original destination of the user and a drop-off location of the item.

Also, a weight based on a total travel distance required for delivery and a weight based on a size and weight of the item may be calculated.

Rewards may be calculated by adding up the calculated weights. For example, if the combined weight is 1, a 2,000 KRW discount on rides may be provided, and if the combined weight is 2 to 3, a 3,000 KRW discount on rides may be provided. The higher the combined weight, the higher the discount amount.

Also, rewards may be calculated by converting an additional travel distance into time. For example, by converting an additional distance traveled by the user to perform both pickup and delivery of the item into time, additional rewards of 100 KRW per minute may be provided.

Rewards may also be calculated based on a weight of the item. For example, if the weight of the item is 3 kg or more, a final reward may be calculated by multiplying a basic reward by 1.1 times.

If a driver of ride-offering service according to another example performs pickup or delivery of an item, rewards may be calculated based on a distance between an origin of the ride-offering service and a pickup location of the item, and a distance between a destination of the ride-offering service and a drop-off location of the item. The calculated rewards may be provided to the driver in various manners.

Similarly to if the user performs both pickup and delivery of an item, if the driver performs both pickup and delivery, rewards may be calculated by converting an additional travel distance into time. For example, by converting an additional distance traveled by the driver to perform both pickup and delivery of the item into time, additional rewards of 100 KRW per minute may be provided.

Likewise, reward calculation based on a weight of the item may also be applied. For example, if a weight of the item is 3 kg or more, a final reward may be calculated by multiplying a basic reward by 1.1 times.

According to still another example, if a driver of ride-offering service performs one of pickup and delivery of an item and a user performs the other one of pickup and delivery, reward calculation may be performed by converting an additional travel distance into time, and a final reward may be calculated based on a weight of the item.

In addition, if the driver performs pickup of an item, a driver's additional travel time for pickup may be calculated on a premise that the user approves the driver's pickup. Rewards based on a delay time may then be calculated for the user based on the driver's additional travel time for pickup.

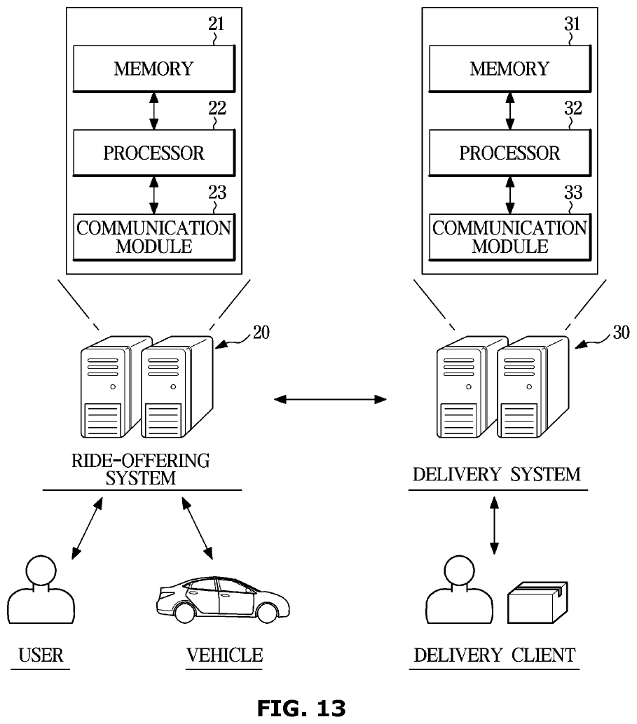

FIG. 13 shows an example of a diagram showing an example where a ride-offering service and a delivery service are intermediated by a ride-offering system.

In the above-described examples, a separate intermediate system intermediates the ride-offering service and the delivery service. According to another example, a ride-offering system may serve as an intermediate system as well.

Referring to FIG. 13, if a ride request is input, a ride-offering system 20 may compare the ride request and a delivery request input to a delivery system 30, and perform matching on the ride request and the delivery request based on an origin and a destination of the ride request and a pickup location and a drop-off location of the delivery request.

The ride-offering system 20 may include at least one memory 21 storing a program performing the operations to be described later, at least one processor 22 implementing a stored program, and a communication module 23 communicating with the intermediate system 1 and a user terminal and a driver terminal of the ride-offering service. The communication module 23 may wirelessly communicate with a base station or an access point (AP), and exchange data with external devices through a base station or an access point. For example, the communication module 23 may wirelessly communicate with an access point using Wi-Fi (Wi-Fi @, IEEE 802.11 standard), or communicate with a base station using a CDMA, WCDMA, GSM, LTE, 5G, Wibro, and the like.

The delivery system 30 includes at least one memory 31 storing a program performing the operations to be described later, at least one processor 32 implementing a stored program, and a communication module 33 communicating with the intermediate system 1, a delivery client and a recipient.

The communication module 33 may wirelessly communicate with a base station or an access point (AP), and exchange data with external devices through a base station or an access point. For example, the communication module 33 may wirelessly communicate with an access point using Wi-Fi (Wi-Fi, IEEE 802.11 standard), or communicate with a base station using a CDMA, WCDMA, GSM, LTE, 5G, Wibro, and the like.

To this end, the ride-offering system 20 may transmit a request for confirming whether a delivery request exists in an adjacent area to the delivery system 30. Specifically, the ride-offering system 20 may transmit, to the delivery system 30, the request for confirming the delivery request having a pickup location, which may be adjacent to the origin included in the ride request or a location of a driver, and a drop-off location which may be adjacent to the destination included in the ride request. Here, an adjacent location (adjacent area) may refer to an area where a distance between two locations is less than a predetermined reference value.

The delivery system 30 may search for whether the delivery request exists in the adjacent area. If the delivery request is retrieved, the delivery system 30 may transmit information related to the delivery request in the adjacent area to the ride-offering system 20.

The ride-offering system 20 may perform matching on the ride request and the delivery request based on the received information related to the delivery request. To perform matching, the ride-offering system 20 may compare a distance between the origin of the ride request or the driver's location and the pickup location of the delivery request with a reference value, and compare a distance between the destination of the ride request and the drop-off location of the delivery request with a reference value.

Here, the reference value may vary depending on whether the pickup or delivery is performed by the user or the driver. Also, the above two reference values for comparison may be the same or different from each other.

A specific description on the matching operation has been made above.

If the ride request and the delivery request match, the ride-offering system 20 may transmit a message for offering the matching delivery to the user requesting a ride or a driver of a vehicle assigned to the corresponding ride request.

Once the user or the driver accepts the delivery offer, the origin or the destination of the ride-offering service may be changed depending on who accepts the offer, which has been already described above, and thus a detailed description thereof is omitted.

Also, a method of calculating and providing a reward to the user or driver who has performed the matching delivery offer may be applied in the same manner as in the above-described examples.

According to the above-described examples, the ride-offering service and the delivery service may be linked to enable a user or a driver of the ride-offering service to perform delivery, and thus more efficient service may be provided.

Specifically, from a perspective of user, delivery may be performed while moving to a destination without any major changes in route, and a fee for ride-offering service may be saved.

From a perspective of driver, income increase may be acquired while providing both the ride-offering service and the delivery service.

Furthermore, vehicle usage may be reduced by performing different service requests by using a single vehicle.

An example of the disclosure provides an intermediate system, an intermediate method and a ride-offering system that may enable a user requesting a ride to provide a delivery service having similar origin and destination by linking a ride-offering service and a delivery service, to provide more efficient services.

Additional examples of the disclosure will be set forth in part in the description which follows and, in part, will be obvious from the description, or may be learned by practice of the disclosure.

According to an example of the disclosure, an intermediate system may include: a communication module configured to communicate with a ride-offering system and a delivery system; and at least one processor configured to perform matching on a ride request transmitted to the ride-offering system and a delivery request transmitted to the delivery system. In response to a delivery request matching the ride request being existent, the at least one processor may be configured to change at least one of an origin or a destination of a ride-offering service corresponding to the ride request based on the matching delivery request.

The at least one processor may be configured to compare the origin and the destination of the ride request with a pickup location and a drop-off location of the delivery request.

The at least one processor may be configured to determine that the delivery request and the ride request match, in response to a distance between the origin of the ride request and a pickup location of the delivery request and a distance between the destination of the ride request and a drop-off location of the delivery request being equal to or less than a reference value.

The at least one processor may be configured to determine that a user inputting the ride request performs pickup of an item of the delivery request, in response to a distance between the origin of the ride request and a pickup location of the delivery request being equal to or less than a first reference value.

The at least one processor may be configured to determine that a user inputting the ride request performs delivery of an item of the delivery request, in response to a distance between the destination of the ride request and a drop-off location of the delivery request being equal to or less than a first reference value.

The at least one processor may be configured to determine that a driver of a share vehicle adjacent to the origin of the ride request performs pickup of an item, in response to a distance between the origin of the ride request and a pickup location of the delivery request exceeding a first reference value and a distance between the origin of the ride request and a location of the share vehicle being equal to or less than a second reference value.

The at least one processor may be configured to determine that a driver of a share vehicle adjacent to the origin of the ride request performs delivery of an item of the delivery request, in response to a distance between the destination of the ride request and a drop-off location of the delivery request exceeding a first reference value.

The at least one processor may be configured to calculate a reward for pickup or delivery of an item corresponding to the delivery request, in response to the delivery request matching the ride request being existent.

According to an example of the disclosure, an intermediate method may include: receiving information related to a ride request from a ride-offering system; performing matching on the ride request with a delivery request transmitted to a delivery system; and in response to a delivery request matching the ride request being existent, changing at least one of an origin or a destination of a ride-offering service corresponding to the ride request based on the matching delivery request.

The performing matching may include comparing the origin and the destination of the ride request with a pickup location and a drop-off location of the delivery request.

The performing matching may include determining that the delivery request and the ride request match, in response to a distance between the origin of the ride request and a pickup location of the delivery request and a distance between the destination of the ride request and a drop-off location of the delivery request being equal to or less than a reference value.

The performing matching may include determining that a user inputting the ride request performs pickup of an item of the delivery request, in response to a distance between the origin of the ride request and a pickup location of the delivery request being equal to or less than a first reference value.

The performing matching may include determining that a user inputting the ride request performs delivery of an item of the delivery request, in response to a distance between the destination of the ride request and a drop-off location of the delivery request being equal to or less than a first reference value.

The performing matching may include determining that a driver of a share vehicle adjacent to the origin of the ride request performs pickup of an item, in response to a distance between the origin of the ride request and a pickup location of the delivery request exceeding a first reference value and a distance between the origin of the ride request and a location of the share vehicle being equal to or less than a second reference value.

The performing matching may include determining that a driver of a share vehicle adjacent to the origin of the ride request performs delivery of an item of the delivery request, in response to a distance between the destination of the ride request and a drop-off location of the delivery request exceeding a first reference value.

The performing matching may include calculating a reward for pickup or delivery of an item corresponding to the delivery request, in response to the delivery request matching the ride request being existent.

According to another example of the disclosure, a ride-offering system may include: a communication module configured to communicate with a user terminal, a driver terminal, and a delivery system; and at least one processor configured to perform matching on a ride request and a delivery request transmitted to the delivery system, in response to the ride request being transmitted from the user terminal. In response to a delivery request matching the ride request being existent, the at least one processor may be configured to change at least one of an origin or a destination of a ride-offering service corresponding to the ride request based on the matching delivery request.

The at least one processor may be configured to compare the origin and the destination of the ride request with a pickup location and a drop-off location of the delivery request.

The at least one processor may be configured to determine that the delivery request and the ride request match, in response to a distance between the origin of the ride request and a pickup location of the delivery request and a distance between the destination of the ride request and a drop-off location of the delivery request being equal to or less than a reference value.

The at least one processor may be configured to determine that a user inputting the ride request performs pickup of an item of the delivery request, in response to a distance between the origin of the ride request and a pickup location of the delivery request being equal to or less than a first reference value.

The at least one processor may be configured to determine that a user inputting the ride request performs delivery of an item of the delivery request, in response to a distance between the destination of the ride request and a drop-off location of the delivery request being equal to or less than a first reference value.

The at least one processor may be configured to determine that a driver of a share vehicle adjacent to the origin of the ride request performs pickup of an item, in response to a distance between the origin of the ride request and a pickup location of the delivery request exceeding a first reference value and a distance between the origin of the ride request and a location of the share vehicle being equal to or less than a second reference value.

The at least one processor may be configured to determine that a driver of a share vehicle adjacent to the origin of the ride request performs delivery of an item of the delivery request, in response to a distance between the destination of the ride request and a drop-off location of the delivery request exceeding a first reference value.

The at least one processor may be configured to calculate a reward for pickup or delivery of an item corresponding to the delivery request, in response to the delivery request matching the ride request being existent.

As is apparent from the above, according to the examples of the disclosure, the intermediate system, the intermediate method and the ride-offering system may enable a user requesting a ride to provide a delivery service having similar origin and destination by linking a ride-offering service and a delivery service, to provide more efficient services.

Meanwhile, the above-described intermediate method may be stored in the form of a recording medium storing computer-executable instructions. The instructions may be stored in the form of a program code, and if executed by a processor, the instructions may perform operations of the disclosed examples.

The recording medium may be implemented as a computer-readable recording medium, and may be a non-transitory computer-readable medium.

The computer-readable recording medium includes all kinds of recording media in which instructions which may be decoded by a computer are stored of, for example, a read only memory (ROM), random access memory (RAM), magnetic tapes, magnetic disks, flash memories, optical recording medium, and the like.

Although examples have been described for illustrative purposes, those skilled in the art will appreciate that various modifications, additions and substitutions are possible, without departing from the scope and spirit of the disclosure. Therefore, examples have not been described for limiting purposes.

What is claimed is:

1. A system comprising:
a communication module configured to communicate with a ride-offering system and a delivery system; and
at least one processor configured to:
perform matching between:
a ride request transmitted to the ride-offering system and
a delivery request transmitted to the delivery system; and
based on the performed matching, change at least one of an origin associated with the ride request or a destination associated with the ride request.

2. The system of claim 1, wherein the at least one processor is further configured to compare:
a pair of the origin and the destination associated with the ride request and
a pair of a pickup location and a drop-off location associated with the delivery request.

3. The system of claim 1, wherein the at least one processor is further configured to determine, based on a distance between the origin associated with the ride request and a pickup location associated with the delivery request being equal to or less than a reference value and a distance between the destination associated with the ride request and a drop-off location associated with the delivery request being equal to or less than the reference value, whether the delivery request and the ride request match.

4. The system of claim 1, wherein the at least one processor is configured to determine, based on a distance between the origin associated with the ride request and a pickup location associated with the delivery request being equal to or less than a first reference value, a user associated with the ride request as a user for picking up an item associated with the delivery request.

5. The system of claim 1, wherein the at least one processor is further configured to determine, based on a distance between the destination associated with the ride request and a drop-off location associated with the delivery request being equal to or less than a first reference value, a user associated with the ride request as a user for delivering an item associated with the delivery request.

6. The system of claim 1, wherein the at least one processor is further configured to determine, based on:
a distance between the origin associated with the ride request and a pickup location associated with the delivery request exceeding a first reference value and
a distance between the origin associated with the ride request and a location associated with a vehicle being equal to or less than a second reference value,
a user of the vehicle as a user for picking up an item associated with the delivery request, wherein the vehicle is adjacent to the origin associated with the ride request.

7. The system of claim 1, wherein the at least one processor is further configured to determine, based on a distance between the destination associated with the ride request and a drop-off location associated with the delivery request exceeding a first reference value, a user of a vehicle adjacent to the origin associated with the ride request as a user for delivering an item associated with the delivery request.

8. The system of claim 1, wherein the at least one processor is further configured to calculate, based on the performed matching, a reward for participating in a delivery service associated with the delivery request.

9. The system of claim 8, wherein the at least one processor is further configured to calculate the reward based on at least one of:
a travel distance associated with a pickup or a delivery of an item,
a size of the item, or
a weight of the item.

10. A method performed by a computing device, the method comprising:
receiving information related to a ride request from a ride-offering system;
performing matching between the ride request and a delivery request transmitted to a delivery system; and
based on the performed matching, changing at least one of an origin or a destination associated with the ride request.

11. The method of claim 10, wherein the performing matching comprises comparing:
a pair of the origin and the destination associated with the ride request and
a pair of a pickup location and a drop-off location associated the delivery request.

12. The method of claim 10, wherein the performing matching comprises determining, based on a distance between the origin associated with the ride request and a pickup location associated with the delivery request being equal to or less than a reference value and a distance between the destination associated with the ride request and a drop-off location associated with the delivery request being equal to or less than the reference value, whether the delivery request and the ride request match.

13. The method of claim 10, wherein the performing matching comprises determining, based on a distance between the origin associated with the ride request and a pickup location associated with the delivery request being equal to or less than a first reference value, a user associated with the ride request as a user for picking up an item associated with the delivery request.

14. The method of claim 10, wherein the performing matching comprises determining, based on a distance between the destination associated with the ride request and a drop-off location associated with the delivery request being equal to or less than a first reference value, a user associated with the ride request as a user for delivering an item associated with the delivery request.

15. The method of claim 10, wherein the performing matching comprises determining, based on:
a distance between the origin associated with the ride request and a pickup location associated with the delivery request exceeding a first reference value and
a distance between the origin associated with the ride request and a location associated with a vehicle being equal to or less than a second reference value, determine a user of the vehicle as a user for picking up an item associated with the delivery request, wherein the vehicle is adjacent to the origin associated with the ride request.

16. The method of claim 10, wherein the performing matching comprises determining, based on a distance between the destination associated with the ride request and a drop-off location associated with the delivery request exceeding a first reference value, a user of a vehicle adjacent to the origin associated with the ride request as a user for delivering an item associated with the delivery request.

17. The method of claim 10, wherein the performing matching comprises calculating, based on the performed matching, a reward for participating in a delivery service associated with the delivery request.

18. A system comprising:
a communication module configured to communicate with a user terminal, a driver terminal, and a delivery system; and
at least one processor configured to:
perform matching between:
a ride request transmitted from the user terminal and
a delivery request transmitted to the delivery system; and
based on the performed matching, change at least one of an origin or a destination associated with the ride request.

19. The system of claim 18, wherein the at least one processor is further configured to compare:
a pair of the origin and the destination associated with the ride request and
a pair of a pickup location and a drop-off location associated the delivery request.

20. The system of claim 18, wherein the at least one processor is further configured to determine, based on a distance between the origin associated with the ride request and a pickup location associated with the delivery request being equal to or less than a reference value and a distance between the destination associated with the ride request and a drop-off location associated the delivery request being equal to or less than the reference value, whether the delivery request and the ride request match.

21. The system of claim 18, wherein the at least one processor is further configured to determine, based on a distance between the origin associated with the ride request and a pickup location associated with the delivery request being equal to or less than a first reference value, a user associated with the ride request as a user for picking up an item associated with the delivery request.

22. The system of claim 18, wherein the at least one processor is further configured to determine, based on a distance between the destination associated with the ride request and a drop-off location associated with the delivery request being equal to or less than a first reference value, a user associated with the ride request as a user for delivering an item associated with the delivery request.

23. The system of claim 18, wherein the at least one processor is further configured to determine, based on:
a distance between the origin associated with the ride request and a pickup location associated with the delivery request exceeding a first reference value and
a distance between the origin associated with the ride request and a location associated with a vehicle being equal to or less than a second reference value, determine a user of the vehicle as a user for picking up an item associated with the delivery request, wherein the vehicle is adjacent to the origin associated with the ride request.

24. The system of claim 18, wherein the at least one processor is further configured to determine, based on to a distance between the destination associated with the ride request and a drop-off location associated with the delivery request exceeding a first reference value, a user of a vehicle adjacent to the origin associated with the ride request as a user for delivering an item associated with the delivery request.

25. The system of claim 18, wherein the at least one processor is further configured to calculate, based on the performed matching, a reward for participating in a delivery service associated with the delivery request.
